(19) United States
(12) Patent Application Publication
(10) Pub. No.: US 2014/0278873 A1
(43) Pub. Date: Sep. 18, 2014

(54) CONTENT SHARING SYSTEM, CONTENT SHARING SERVER APPARATUS, CONTENT SHARING METHOD AND RECORDING MEDIUM

(71) Applicant: NINTENDO CO., LTD., Kyoto (JP)

(72) Inventors: Hideaki SHIMIZU, Kyoto (JP); Yoshiaki KOIZUMI, Kyoto (JP)

(73) Assignee: NINTENDO CO., LTD., Kyoto (JP)

(21) Appl. No.: 14/202,808

(22) Filed: Mar. 10, 2014

(30) Foreign Application Priority Data
Mar. 12, 2013 (JP) 2013-049431

(51) Int. Cl. G06Q 30/02; G06Q 50/00

(52) U.S. Cl. CPC G06Q 30/0217; G06Q 50/01
USPC 705/14.19; 709/204

(57) ABSTRACT

An example system includes: a terminal device accepting operation of contributing content by a contributor or accepting operation by an evaluator of evaluating published content or a contributor who contributed content; and a content sharing server apparatus having a value information providing unit providing value information to a user, a content contribution acceptance unit accepting contribution of content from a contributor through communication with the terminal device, and an evaluation acceptance unit accepting an evaluation, for contributed content or a contributor who contributed content, from an evaluator with reduction in value of the value information through communication with the terminal device.

### CROSS-REFERENCE TO RELATED APPLICATIONS

This application is based upon and claims the benefit of priority of the prior Japanese Patent Application No. 2013-049431, filed on Mar. 12, 2013, the entire contents of which are incorporated herein by reference.

### FIELD

The technology herein relates to a content sharing system, a content sharing server apparatus, a content sharing method and a recording medium that are capable of, for example, contributing content and evaluating contributed content.

### BACKGROUND AND SUMMARY

Conventionally, a content sharing system has been known in which content such as an image or music created and contributed by a user may be published on a website and the published content may be evaluated by another user. A server apparatus used in the system may perform processing of, for example, aggregating the results of evaluation by users, ranking content, and announcing the ranking as popularity ranking.

According to an aspect of the embodiment, a content sharing system in which contributed content is published on a network so as to be shared among a plurality of users includes: a terminal device accepting operation of contributing content by a contributor or accepting operation by an evaluator of evaluating published content or a contributor who contributed content; and a content sharing server apparatus having a value information providing unit providing value information to a user, a content contribution acceptance unit accepting contribution of content from a contributor through communication with the terminal device, and an evaluation acceptance unit accepting an evaluation, for contributed content or a contributor who contributed content, from an evaluator with reduction in value of the value information through communication with the terminal device.

The object and advantages of the present disclosure will be realized and attained by means of the elements and combinations particularly pointed out in the claims. It is to be understood that both the foregoing general description and the following detailed description are exemplary and explanatory and are not restrictive of the invention.

The above and further objects and features of the present disclosure will more fully be apparent from the following detailed description with accompanying drawings.

### BRIEF DESCRIPTION OF THE DRAWINGS

FIG. 1 shows an example non-limiting block diagram illustrating a configuration of a content sharing system according to an embodiment;

FIG. 2 shows an example non-limiting block diagram illustrating a configuration of a content sharing system according to an embodiment;

FIG. 3 shows an example non-limiting schematic diagram for illustrating a content sharing service according to an embodiment;

FIG. 4 shows an example non-limiting flowchart illustrating a procedure of login processing performed by a content sharing server apparatus;

FIG. 5 shows an example non-limiting flowchart illustrating a procedure of content contribution acceptance processing performed by a content sharing server apparatus;

FIG. 6 shows an example non-limiting flowchart illustrating a procedure of content publication processing performed by a content sharing server apparatus;

FIG. 7 shows an example non-limiting flowchart illustrating a procedure of reward giving processing for a contributor, performed by a content sharing server apparatus;

FIG. 8 shows an example non-limiting flowchart illustrating a procedure of reward giving processing for an evaluator, performed by a content sharing server apparatus; and

FIG. 9 shows an example non-limiting flowchart illustrating a procedure of reward giving processing for an evaluator, performed by a content sharing server apparatus.

### DETAILED DESCRIPTION OF NON-LIMITING EXAMPLE EMBODIMENTS

### <System Configuration>

FIGS. 1 and 2 are block diagrams each illustrating a configuration of a content sharing system according to an embodiment. The content sharing system according to the present embodiment has such a configuration that a content sharing server apparatus 1 and multiple terminal devices 5 are connected with each other through a network NW. Each of the terminal devices 5 is utilized by the user of a content sharing service offered by the present system for, e.g., creating, contributing, viewing and evaluating content. A user may contribute the content created by the user to the content sharing server apparatus 1 through the network NW using the terminal device 5. In the present embodiment, the content may be, for example, a static image, a moving image, voice, music or an application program. With the terminal device 5, a user is able to view the content contributed by another user. A user may evaluate the viewed content by contribution, comment positing or the like. It is noted that contribution of comments here means that, for example, data including text information on contributed content or a contributor is contributed from the terminal device 5 to the content sharing server apparatus 1. The text information in a comment typically corresponds to information such as an impression or opinion for the content or contributor.

FIG. 1 shows a detailed configuration of the content sharing server apparatus 1. The content sharing server apparatus 1 is provided with a processing unit 10, a storage unit 11, a display unit 12, an operation unit 13, a recording medium attachment unit 14, a communication unit 15 and the like. The processing unit 10 is configured with an arithmetic processing device such as a CPU (Central Processing Unit) or MPU (Micro Processing Unit). The processing unit 10 reads out and executes a server program 81 stored in the storage unit or a server program 81 recorded in a recording medium 8 attached to the recording medium attachment unit 14. By executing the server program 81, the processing unit 10 performs various types of information processing concerning the content sharing service. For example, the processing unit 10 performs processing of accepting contribution of content, publishing the contributed content, accepting an evaluation for content, and giving a reward to a contributor or an evaluator of content.

The storage unit 11 is configured with a storage device such as a hard disk. The storage unit 11 stores therein data such as content contributed by a user and a program such as the server program 81 to be executed in the processing unit 10. The display unit 12 is configured with a liquid crystal panel, a PDP (Plasma Display Panel) or the like. The display unit 12 displays an image sent from the processing unit 10. The operation unit 13 is configured with an input device such as, for example, a keyboard and/or a mouse. The operation unit 13 reports details of operation performed by the user to the processing unit 10. The recording medium attachment unit 14 is so configured that a recording medium 8 of a card type, a cassette type, a disk type or the like may be attached thereto and removed therefrom. The processing unit 10 may read out the server program 81 and other data from the recording medium 8 attached to the recording medium attachment unit 14. The communication unit 15 transmits and receives data to/from another device such as the terminal device 5 through the network NW such as the Internet.

In the content sharing server apparatus 1 according to the present embodiment, the processing unit 10 executes the server program 81 so that the contribution acceptance processing unit 21, publication processing unit 22, evaluation acceptance processing unit 23, reward giving processing unit 24 and the like are realized as software-like function blocks. The contribution acceptance processing unit 21 performs processing of accepting the contribution of content from the terminal device 5 through the network NW. The publication processing unit 22 performs processing of publishing the content stored in the storage unit 11. This allows each user utilizing the terminal device 5 to view the content contributed by another user. The evaluation acceptance processing unit 23 performs processing of accepting an evaluation for the published content from the terminal device 5 through the network NW. The reward giving processing unit 24 performs processing of giving a reward to a contributor and an evaluator of content.

FIG. 2 shows a detailed configuration of the terminal device 5. The terminal device 5 may correspond to various types of information processing devices such as, for example, a game machine, a mobile phone, a smart phone, a tablet terminal, a personal computer or the like. The terminal device 5 is provided with a processing unit 50, a storage unit 51, a display unit 52, an operation unit 53, a storage medium attachment unit 54, a communication unit 55 and like. The processing unit 50 reads out and executes a client program 91 stored in the storage unit 51 or a client program 91 recorded in the recording medium 9 attached to the recording medium attachment unit 54. The execution of the client program 91 allows the processing unit 50 to perform various types of information processing concerning a content sharing service.

In the storage unit 51, the content created by the user at the terminal device 5, the client program 91 to be executed at the processing unit 50 and the like are stored. The display unit 52 displays an image sent from the processing unit 50. The operation unit 53 accepts the operation of the user and reports it to the processing unit 50. The recording medium attachment unit 54 may attach and remove the recording medium 9 thereto/therefrom. The processing unit 50 may read out the client program 91 and other data from the recording medium 9 attached to the recording medium attachment unit 54. The communication unit 55 transmits/receives data to/from the content sharing server apparatus 1 through the network NW.

In the terminal device 5 according to the present embodiment, the processing unit 50 executes a client program 91 so that a content creation processing unit 61, a contribution processing unit 62, a viewing processing unit 63, an evaluation processing unit 64 and the like are realized as software-like function blocks. The content creation processing unit 61 performs various types of processing required for the user of the terminal device 5 to create content. When content is a static image, the content creation processing unit 61 performs processing of drawing, coloring and the like of a point or a line based on the user's operation with respect to the operation unit 53. Here, the content creation processing unit 61 performs processing corresponding to so-called painting software, drawing software, video editing software, voice/music editing software and the like. The content created by the content creation processing unit 61 is stored in the storage unit 51.

The contribution processing unit 62 performs processing of contributing the content created by the content creation processing unit 61 and stored in the storage unit 51 to the content sharing server apparatus 1. It is not necessary for the content to be created at the terminal device 5. The content may also be created in an external information processing device different from the terminal device 5 and transferred to the terminal device 5. The external information processing device may be, for example, a game machine, a mobile phone, a smartphone, a tablet terminal or a personal computer. The viewing processing unit 63 performs processing for viewing the content contributed to the content sharing server device 1. The evaluation processing unit 64 performs processing for evaluation such as voting or posting comments on the viewed content.

### <Summary of Content Sharing Service>

In the content sharing system according to the present embodiment, a client program 91 to be executed in the terminal device is offered free of charge. The content sharing service offered by the content sharing server device 1 is, however, paid for. Thus, the user of the content sharing service needs to pay a fee with the terminal device 5 before he/she starts using it. For example, the content sharing server apparatus 1 sells a right to use the content sharing service for a predetermined period (e.g., thirty days) as a “service use ticket” for a predetermined price (e.g., one hundred yen). In the present embodiment, the predetermined period is referred to a “service use period.” The user accesses the content sharing server apparatus 1 using the communication function of the terminal device 5, and purchases a “service use ticket” with electronic money, a credit card or the like. The use of a “service use ticket” in the terminal device 5 allows the user to utilize the content sharing service for a service use period from the time point at which the service use ticket is used.

In the present embodiment, the use of a paid content sharing service includes contribution, viewing, evaluation and the like for content by the user. The use of the paid content sharing service, however, does not include creation of content at the terminal device 5. The creation of content may be performed free. The user who first uses the content sharing service performs processing of registering necessary information such as an ID (IDentifier) and a password to the content sharing server apparatus 1. When a service use period has elapsed, the user may continue using the content sharing service with the same ID by again purchasing a “service use ticket.”

The content sharing server apparatus 1 supplies the user who purchased and used a “service use ticket” with a coin as currency used in the content sharing service. In the present embodiment, two types of coins, i.e. a special coin and a normal coin, are present. For example, the content sharing server 1 supplies each user with three special coins and one hundred normal coins. With the received coins, the user is able to, for example, contribute and evaluate content. It is noted that viewing of content would not require any coins.

The coins provided to each user has a predetermined expiration period. The coins will be unusable, or the number of remaining coins will be zero, when the same service use period as that of a “service use ticket” has elapsed. In the present embodiment, the upper limit for the number of coins provided to each user is determined. For example, the user will not be supplied with additional coins by paying an additional fee. This may limit the amount of actions, such as contribution and evaluation of content, which may be performed by each user within a service use period. Accordingly, problems such as increase in the processing load on the content server apparatus 1, exclusive use of the service by a specific user and the like may be prevented.

A user may create content by executing the client program 91 in the terminal device 5. As described above, the user may enjoy creating content free of charge. In the terminal device 5, the content creation processing unit 61 in the processing unit 50 performs processing of, for example, accepting operation concerning content creation by the user and saving the created content in the storage unit 51. Using the communication unit 55, the terminal device 5 is capable of communicating with another terminal device 5 without intermediation of the content sharing server apparatus 1. A user can directly communicate with the terminal device 5 owned by another user, such as a friend, with his/her terminal device 5 and can transmit/receive the content stored in the storage unit 51. The user may also perform such transmission/reception of content by communication without intermediation of the content sharing server apparatus 1 free of charge.

FIG. 3 shows an example non-limiting schematic diagram for illustrating a content sharing service according to the present embodiment. The user who is supplied with special coins and normal coins can contribute and evaluate content using these coins. In other words, the user of this service may be either a contributor or an evaluator of content. A contributor uses coins to contribute created content to the content sharing service. An evaluator uses coins to evaluate the contributed content. The contributor receives a reward in accordance with the evaluation for the contributed content. The evaluator receives a reward for the evaluation.

Accordingly, in the content sharing service according to the present embodiment, both a contributor and an evaluator of content act for contribution and evaluation using coins with a determined upper limit. Rewards are given to the contributor and evaluator for those actions. The rewards to the contributor and evaluator include additional coins or increase in the number of coins to be given. In the present service, therefore, coins may be circulated between contributors and evaluators.

### <Contribution of Content>

The user who created content may contribute the content to the content sharing server apparatus 1. The contribution processing unit 62 of the terminal device 5, for example, displays a list of created content stored in the storage unit 51. The contribution processing unit 62 accepts selection of content to be contributed in accordance with the operation for the operation unit 53. The contribution processing unit 62 transmits the selected content to the content sharing server apparatus 1 through communication by the communication unit 55. The contribution acceptance processing unit 21 of the content sharing server apparatus 1 receives the content transmitted from the terminal device 5. The contribution acceptance processing unit 21 accepts the received content as contributed content and stores it in the storage unit 11.

It is noted that, in the present embodiment, to contribute content, one coin needs to be consumed, i.e. value information needs to be reduced in its value. The number of coins to be consumed may be one, either a special coin or a normal coin. The user who contributes content may select, at his/her will, a coin to be consumed. The information on the number of coins owned by each user or the like is managed by the content sharing server apparatus 1. As contribution of content is accepted, the number of coins owned by the user, which is managed by the content sharing server apparatus 1, is reduced.

The content contributed using a normal coin has a determined period for which the content is held in the content sharing server apparatus 1. When a predetermined period (thirty days, for example) has elapsed from the time point when the content is contributed, the content is deleted from the storage unit 11. In the present embodiment, the predetermined period is referred to as a “content holding period.” However, the content satisfying a predetermined condition as a result of the evaluation for the content, which will be described later, will not be deleted even if the content holding period has elapsed. By contrast, the content contributed using a special coin will not be restricted by a content holding period and the like. The content contributed using a special coin is held in the content sharing server apparatus 1 and continues to be published.

### <Publishing and Viewing of Content>

The content sharing server apparatus 1 performs the processing of publishing contributed content at the publication processing unit 22. Each user may view the content published at the content sharing server apparatus 1 using the terminal device 5. The terminal device 5 accepts a request for viewing content shared in the content sharing service in accordance with the user's operation for the operation unit 53. When the request for viewing is accepted, the viewing processing unit 63 of the terminal device 5 transmits the request for viewing to the content sharing server apparatus 1. In the content sharing server apparatus 1 which received the request for viewing, the publication processing unit 22 of the processing unit 10 creates a list based on the title, thumbnail or the like of the content stored in the storage unit 11. The publication processing unit 22 transmits the created list to the terminal device 5 concerning the request for viewing. Here, the publication processing unit 22 sets a difference in the degree of publication between the content contributed with a special coin and the content contributed with a normal coin. For example, the publication processing unit 22 displays the content contributed with a special coin at the head of the list or displays such content by highlighting it. The viewing processing unit 63 of the terminal device 5 that received the list of content from the content sharing server apparatus 1 generates an image for display based on the received list and outputs it to the display unit 52. Thus, the terminal device 5 displays the list of content on the display unit 52.

For the list of contents displayed on the display unit 52 of the terminal device 5, the user performs operation with the operation unit 53, to select the content he/she wishes to view the details thereof. When the selection of content made by the user is accepted, the viewing processing unit 63 of the terminal device 5 transmits a request for viewing details, which specifies the selected content, to the content sharing server apparatus 1. The publication processing unit 22 of the content sharing server apparatus 1 which received the request for viewing details reads out the specified content from the storage unit 11 and transmits it to the terminal device 5 concerning the request for viewing details. The viewing processing unit 63 of the terminal device 5 which received the content from the content sharing server apparatus 1 realizes viewing by a method suitable for the content. If, for example, the content is a static image, the viewing processing unit 63 displays the received static image on the display unit 52. If, for example, the content is a video image, the viewing processing unit 63 performs processing of playing the video image, and displays the image on the display unit 52 while outputting sound from a speaker. If, for example, the content is music, the viewing processing unit 63 plays the music and outputs it from a speaker or the like. Though, in the present embodiment, the expression “viewing” is used for content for convenience, this also includes other actions such as listening to music or watching video images.

### <Evaluation of Content>

The user who viewed the published content at the terminal device 5 can evaluate the content in accordance with his/her predilection. In the content sharing service according to the present embodiment, two methods, i.e. voting and comment posting, are employed as methods of evaluating content. When, for example, the user is viewing content with the terminal device 5, the evaluation processing unit 64 of the terminal device 5 displays a vote button, a comment button and the like on the display unit 52. Using the displayed vote button, comment button and the like, the evaluation processing unit 64 accepts user's operation of voting or comment posting through the operation unit 53. It is noted that one coin needs to be used for evaluation when the user employs either one of the evaluation methods of voting and comment posting. The coin to be used may be either a special coin or a normal coin. However, the user who contributed content cannot evaluate his/her own content. It is possible for the same user to evaluate one content several times. The “evaluation” here may include, other than the user voting for or posting comments on content, the user registering the content to a bookmark, which will be described later.

The user votes for the content of his/her preference using a coin to give a high rating to the content. The evaluation processing unit 64 of the terminal device 5 accepts operation of voting for the content. The evaluation processing unit 64 notifies the content sharing server apparatus 1 that voting is performed for the content together with information indicating a type of the coin used. The content sharing server apparatus 1 manages the number of votes with respect to each type of coins for each content. The evaluation acceptance processing unit 23 of the content sharing server apparatus 1 which received a notification from the terminal device 5 that voting is performed increases the number of votes for the content concerning the notification. The evaluation acceptance processing unit 23 reduces the number of coins possessed by the user who performed the voting. The number of votes for content is displayed as accompanying information when, for example, a list of contents is displayed. For example, an indication such as “number of votes: 3 special coins, 26 normal coins” is displayed.

The user can write a comment on content using a coin. The comment may be good or bad for the content. Thus, in the present embodiment, the number of coins used for comment is not included in the number of votes described above. A comment is not limited to text but may take a form of image, voice or the like. The evaluation processing unit 64 of the terminal device 5 accepts input of a comment. The evaluation processing unit 64 transmits the input comment to the content sharing server apparatus 1 together with the information indicating a type of coin used. The evaluation acceptance processing unit 23 of the content sharing server apparatus 1 which received the comment stores the comment in association with the content in the storage unit 11. The evaluation acceptance processing unit 23 reduces the number of coins owned by the user who posted the comment. The comment stored in the storage unit 11 in association with the content is displayed as accompanying information when, for example, the content is viewed. The comment posted using a special coin is displayed by, for example, highlighting it so as to be distinguishable from the comment posted using a normal coin.

The user can vote for the contributor of content using a coin, as in the case with the voting for one published content. In the present embodiment, however, a vote for a contributor needs a special coin. When operation of voting for a user is accepted, the evaluation processing unit 64 of the terminal device 5 notifies the content sharing server apparatus 1 that a vote for the user is performed. The content sharing server apparatus 1 manages the number of votes for each coin with respect to each user. In the present embodiment, the number of votes for each user corresponds to the total number of direct votes for the user and votes for all the content contributed by the user. The evaluation acceptance processing unit 23 of the content sharing server apparatus 1 which received from the terminal device 5 the notification indicating that voting is performed for a user increases the number of votes for the user. The evaluation acceptance processing unit 23 reduces the number of special coins possessed by the user who performed the voting. The number of votes for the user is displayed together with the information such as the name of a contributor for content. For example, an indication such as “the number of votes for user A: 10 special coins, 355 normal coins” is displayed.

### <Reward to Contributor>

As described above, the content contributed using a normal coin is deleted when a content holding period has elapsed since the contribution. When, however, the number of coins obtained by voting satisfies a predetermined condition, the content contributed using a normal coin is exempted from deletion at expiration of the content holding period. In the present embodiment, the predetermined condition is referred to as a “delete exemption condition”. This is one of the rewards given by the reward giving processing unit 24 of the content sharing server apparatus 1 for the content which attained a high rating. The reward giving processing unit 24 sets the delete exemption condition as to obtain, for example, fifteen or more special coins, or one hundred or more normal coins. When the content contributed using a normal coin satisfies the delete exemption condition within the content holding period, the reward giving processing unit 24 exempts deletion at expiration of the content holding period. Here, the reward giving processing unit 24 may also extend the content holding period instead of exempting deletion.

Thus, the user who viewed content may vote for the content he/she likes so as to prevent the content from being deleted. The content sharing server apparatus 1 may also transmit information on whether or not the content was contributed using a normal coin, the number of votes of coins at the current time point, a remaining period until deletion or the like to the terminal device 5 for each content to be published, and provide the user who views the content using the terminal device 5 with such information.

When the number of coins obtained by the user who contributed content satisfies a predetermined condition, the reward giving processing unit 24 of the content sharing server apparatus 1 supplies the user with a “service use ticket” for using the content sharing service. In the present embodiment, the predetermined condition is referred to as a “service use ticket obtaining condition.” The reward giving processing unit 24 sets a service use ticket obtaining condition as to obtain, for example, twenty or more special coins, or one thousand or more normal coins within one service use period. The reward giving processing unit 24 supplies the user with a “service use ticket” when the number of votes obtained by a user satisfies the service use ticket obtaining condition. The “service use ticket” to be supplied as a reward is substantially the same as the one purchased by the user for using the content sharing service. The user who is supplied with the “service use ticket” as a reward can use the service free of charge the next time by using the service use ticket after the current service use period has elapsed. The “service use ticket” supplied as a reward has, however, a determined period of validity such as six months, one year or the like, and thus cannot be used after the period of validity has expired.

Accordingly, the reward giving processing unit 24 thus supplying the user with a “service use ticket” as a reward allows the contributor who repeatedly contributes highly-rated content can continuously use the content sharing service free of charge. A “service use ticket” to be given as a reward corresponds to a right to use the content sharing service to be given as a reward, and also to a coin supplied for the use of a service use ticket to be given as a reward. It is noted that the service use ticket obtaining condition may determine for each content contributed by a user instead of coins obtained by the user. Here, in the case where the service use ticket obtaining condition is satisfied for any content, the reward giving processing unit 24 gives a “service use ticket” to the contributor of that content. Though the reward giving processing unit 24 gives a “service use ticket” as a reward in the present embodiment, the reward is not limited thereto. It may also be so configured, for example, that the reward giving processing unit 24 directly gives a special coin or a normal coin to the user as a reward.

The content sharing server apparatus 1 adds up the coins obtained by the published content for a predetermined aggregation period, such as one month. Here, the content sharing server apparatus 1 may add up coins by converting, for example, one special coin into one hundred normal coins. According to the result of aggregation, the content sharing server apparatus 1 determines popularity ranking of content and the publication processing unit 22 publishes the determined popularity ranking. The reward giving processing unit 24 gives an “additional coin ticket” as a reward to, for example, each of the contributors of highly-ranked content, e.g., the first to tenth from the highest. The “additional coin ticket” is a ticket which is able to increase the number of coins given to the user by using it with a “service use ticket.” The content sharing server apparatus 1 increases the number of supplied special coins by, for example, three for one “additional coin ticket.” It is noted that the content sharing server apparatus 1 regards the highly-ranked content in the popularity ranking provided with the “additional coin ticket” as entering the Hall of Frame and excludes it from the subsequent popularity ranking. This can avoid the same content being repeatedly ranked high in the popularity ranking.

The reward giving processing unit 24 of the content sharing server apparatus 1 provides a user with contribution points according to the number of coins obtained by the user from the votes for the content or user. The content sharing server apparatus 1 manages a user level for each user. The user level starts from level one and increases as the user obtains a contribution point according to a contribution or an evaluation point which will be described later. The content sharing server apparatus 1 determines the number of coins supplied to the user when a “service use ticket” is used, in accordance with the user level for the user. In other words, the number of coins to be supplied to the user is increased as the user level is raised.

Though, in the present embodiment, the condition of giving a reward to a contributor is determined in accordance with the number of coins obtained by the content or contributor, it is not limited thereto. When the same evaluator performs evaluations for multiple times on the same content or contributor, the evaluations may be counted as once. That is, the condition of giving a reward to a contributor may be determined in accordance with, for example, the number of evaluators who voted for the content or contributor. Also when the number of either coins or persons is set as a criterion, the period for adding up such number may be any period, not limited to the service use period of service, one month or the like. It is also possible to make a determination in accordance with the number of accumulated coins or persons obtained by the content or contributor without limiting the period.

### <Bookmark Function>

The content sharing server apparatus 1 creates, for each user, the list of contents or users voted for by that user, and holds and manages it. In the present embodiment, the list is referred to as a bookmark. Each user operates to display a bookmark on the terminal device 5 so as to be able to obtain the bookmark from the content sharing server apparatus 1 and display it on the display unit 52. The viewing processing unit 63 of the terminal device 5 accepts the operation of displaying a bookmark at the operation unit 53 and requests the content sharing server apparatus 1 to transmit the bookmark. In response to the request from the terminal device 5, the publication processing unit 22 of the content sharing server apparatus 1 reads out the bookmark of the user concerning the request from the storage unit 11, and transmits it to the terminal device 5. The viewing processing unit 63 of the terminal device 5 receives the bookmark transmitted from the content sharing server apparatus 1 and displays it on the display unit 52.

The bookmark displayed on the display unit 52 of the terminal device 5 includes two types of pages, i.e. a page on which the list of contents is displayed and a page on which the list of users is displayed. In the display of the bookmark, these pages may be switched with each other by the operation through the operation unit 53. The list of contents in the bookmark displays which one of the special coin or normal coin is used for voting in a distinguishable manner. When any one content is selected from the list of contents, a request for viewing the selected content is transmitted from the terminal device 5 to the content sharing server apparatus 1. In response to the viewing request, the content is transmitted from the content sharing server apparatus 1 and displayed on the display unit 52 of the terminal device 5.

When any one of the users is selected from the list of users, the terminal device 5 requests the list of contents contributed by the selected user to the content sharing server apparatus 1. In response to the request, the content sharing server apparatus 1 transmits the list of contents. The terminal device 5 receives the list of contents and displays it on the display unit 52. Moreover, when one content is selected from the list of contents, the selected content is transmitted from the content sharing server apparatus 1 to the terminal device 5 and displayed on the display unit 52. As described above, it is necessary to vote for a user with a special coin. It is thus unnecessary to display in a distinguishable manner which one of the coins is used by each user for voting in the list of users in the bookmark.

When transmitting a bookmark to the terminal device 5, the content sharing server apparatus 1 transmits the bookmark to the terminal device 5 together with the information indicating presence/absence of newly-arrived content for each user included in the list of users in the bookmark. Whether the content for each user is new or not is determined based on whether or not the user who owns the bookmark viewed that content. By notifying the user with new arrival, the user who views the content can surely view the content newly contributed by his/her favorite user without missing it.

### <Reward to Evaluator: 1>

The reward giving processing unit 24 of the content sharing server apparatus 1 gives, to the user who performed voting, an evaluation point in accordance with the degree of attention (popularity indicator) for the content or user to be voted for. As described above, the content sharing server apparatus 1 manages the user level of each user, and raises the user level in accordance with the evaluation points obtained by each user. As the user level is raised, the content sharing server apparatus 1 increases the number of coins to be supplied to the user.

The reward giving processing unit 24 calculates evaluation points as described below, for example. When the user votes for one content, the reward giving processing unit 24 checks the evaluation for that content at the time of voting and stores it. The evaluation item to be stored may be the number of coins obtained by the content, for example. Subsequently, when a predetermined period, e.g., thirty days, has elapsed from the voting for the content, the reward giving processing unit 24 checks the evaluation details for the content at the time point when the predetermined period has elapsed. The reward giving processing unit 24 calculates the difference between the evaluation at the time point when the predetermined period has elapsed and the evaluation at the time point of voting, and gives an evaluation point in accordance with the difference. In other words, the reward giving processing unit 24 gives a larger number of evaluation points to the user as the difference between the above-described time points are larger. Thus, the user is provided with evaluation points after the evaluation is made for the content.

The reward giving processing unit 24, however, excludes the content contributed by the user who has already highly evaluated from the calculation for evaluation points. The highly evaluated user may be, for example, a user whose user level is not less than a predetermined level, or a user who has been ranked high in the content popularity ranking. The user who evaluates content searches for the content contributed by a user who has not yet been ranked high, such as a new user, and votes for the content which is expected to be ranked high in the future, so as to possibly obtain high evaluation points as a reward. This can provide the evaluating user with joy of discovering a new creator.

Though, in the calculation method of the above-described evaluation points, the evaluation points are calculated in accordance with the difference between evaluations for content at the time of voting and at the time when a predetermined period has elapsed, the calculation method is not limited thereto. When, for example, the evaluation details for each content is not published, evaluation points may be calculated in accordance with the evaluation for the content at the time of voting. As the evaluation for content, it is also possible to use the number of obtained coins in a unit period of, e.g., one week, instead of using the number of total coins obtained by the content. As evaluation for content, for example, the number of users who voted for content may also be used.

### <Reward to Evaluator: 2>

In the content sharing service according to the present embodiment, each user can publish his/her own bookmark to another user. Each user refers to the published another user's bookmark to view the content registered under the bookmark. The reward giving processing unit 24 of the content sharing server apparatus 1 provides the user having this bookmark with an evaluation point in accordance with the situation in which the bookmark is referred to by another user. The content sharing server apparatus 1 raises the user level in accordance with the obtained evaluation points and increases the number of coins supplied to the user.

When another user refers to the published bookmark to view content and votes for the content, the reward giving processing unit 24 gives an evaluation point to the user who published the bookmark. Thus given evaluation point raises the user level of the user who published the bookmark. As described above, the content sharing server apparatus 1 increases the number of coins supplied to the user in association with the raise in the user level.

The reward giving processing unit 24 adds up the evaluation points obtained by another user referring to the bookmark for a predetermined period such as one month, for example. The reward giving processing unit 24 creates and publishes the popularity ranking of the bookmark based on the total evaluation points obtained during the predetermined period. The reward giving processing unit 24 gives a “service use ticket” as a reward to the user who published a highly ranked bookmark. For the “service use ticket” to be given as a reward, a period of validity such as six months or one year, for example, is determined.

Though the reward giving processing unit 24 is configured to give an evaluation point to the user who published a bookmark when another user views and votes for the content with reference to the bookmark, the method of giving a reward is not limited thereto. For example, the reward giving processing unit 24 may also have such a configuration that the user who published a bookmark is provided with an evaluation point even when another user only views content with reference to the bookmark but does not vote for the content.

The reward giving processing unit 24 may give an evaluation point, for example, every time when content is voted for or viewed with reference to a bookmark. The reward giving processing unit 24 may give an evaluation point every time a predetermined period of, for example, the service use period of service or one month, has elapsed. The amount of evaluation points given by the reward giving processing unit 24 may be determined depending on, for example, the number of times, i.e. total number of times, content is voted for or viewed with reference to a bookmark. The amount of evaluation points may also be determined depending on, for example, the number of times, i.e. frequency, voting or viewing is performed during a predetermined period. It is also possible for the reward giving processing unit 24 to determine the amount of evaluation points to be given by regarding the reference of the same bookmark by the same user multiple times as one reference. In other words, the amount of evaluation points to be given may be determined depending on the number of users who referred to a bookmark. The reward giving processing unit 24 may also determine the amount of evaluation points depending on a calculated ratio of the number of votes or viewings with reference to a bookmark to the number of users who referred to the bookmark.

### <Details of Processing Procedure>

The procedure of processing performed by the content sharing server apparatus 1 is now described with reference to a flowchart.

FIG. 4 shows an example non-limiting flowchart illustrating a procedure of login processing performed by the content sharing server apparatus 1. The user who wishes to use the content sharing service makes a login request to the service through the terminal device 5. The processing unit 10 of the content server apparatus 1 determines whether or not the login request is accepted from the terminal device 5 (step S1). If the login request is not accepted (S1: NO), the processing unit 10 waits until the login request is accepted. If the login request is accepted (S1: YES), the processing unit 10 performs authentication processing by transmitting and receiving information such as a user ID and a password to/from the terminal device 5 (step S2). If the authentication processing fails, the processing unit 10 performs processing of making the terminal device 5 display a message or the like urging the creation of a new user ID. This processing will, however, not be described in detail here.

After the authentication processing is completed, the processing unit 10 determines whether or not the time of login is within the service use period with the user of a “service use ticket” (step S3). If it is within the service use period (S3: YES), the processing unit 10 performs processing of making the terminal device 5 display the top menu of the content sharing service (step S8), and terminates the processing. If it is not within the service use period (S3: NO), the processing unit 10 displays a message urging the use of a “service use ticket” (step S4). The processing unit 10 determines whether or not the “service use ticket” is used (step S5). If the “service use ticket” is not used (S5: NO), the processing unit 10 returns the processing to step S4 and continues display of the message.

If the “service use ticket” is used (S5: YES), the processing unit 10 supplies the user with a predetermined number of coins (step S6). It is noted that the user can use an “additional coin ticket” with the “service use ticket.” In the case where the “additional coin ticket” is used, the processing unit 10 increases the number of coins to be supplied. Subsequently, the processing unit 10 updates information concerning the user, such as the number of possessed coins and the service use period of service (step S7). The processing unit 10 performs processing of making the terminal device 5 display the top menu of the content sharing service (step S8) and terminates the processing. On the top menu, for example, items such as contribution of content, viewing of content and viewing of another user's bookmark are displayed.

FIG. 5 shows an example non-limiting flowchart illustrating a procedure of content contribution acceptance processing performed by the content sharing server apparatus 1. The contribution acceptance processing unit 21 in the processing unit 10 of the content sharing server apparatus 1 determines whether or not content is contributed from the terminal device 5 (step S11). If no content is contributed (S 11: NO), the contribution acceptance unit 21 waits until content is contributed. If content is contributed (S11: YES), the contribution acceptance processing unit 21 receives the content from the terminal device 5 at the communication unit 15 (step S12). The contribution acceptance processing unit 21 stores the received content in the storage unit 11 (step S13).

The content acceptance processing unit 21 in the processing unit 10 determines whether or not the received and stored content is contributed using a special coin (step S14). If the content is contributed using a special coin (S14: YES), the contribution acceptance processing unit 21 proceeds to step S16. If the content is contributed using a normal coin (S14: NO), the contribution acceptance processing unit 21 sets a period for deleting the content (step S15) and proceeds to step S16.

The contribution acceptance processing unit 21 in the processing unit 10 updates, for the user who contributed content, user information such as the number of possessed coins and contributed content (step S16). The contribution acceptance processing unit 12 publishes the contributed content (step S17). The contribution acceptance processing unit 12 notifies the user who has registered the contributor of the content in a bookmark that new content is published (step S18), and terminates the processing.

FIG. 6 shows an example non-limiting flowchart illustrating a procedure of content publication processing performed by the content sharing server apparatus 1. The publication processing unit 22 in the processing unit 10 of the content sharing server apparatus 1 determines whether or not a request for viewing content is accepted from the terminal device 5 (step S21). If the request for viewing content is not accepted (S21: NO), the publication processing unit 22 waits until the request for viewing is accepted. If the request for viewing content is accepted (S21: YES), the publication processing unit 22 creates a list of contents stored in the storage unit 11 (step S22). The publication processing unit 22 transmits the created list of contents to the terminal device 5 concerning the viewing request (step S23).

The publication processing unit 22 determines whether or not a request for viewing details of content is accepted from the terminal device 5 based on the transmitted list of contents (step S24). If the request for viewing details of content is not accepted (S24: NO), the publication processing unit 22 waits until the request for viewing details is accepted. If the request for viewing details of content is accepted (S24: YES), the publication processing unit 22 reads out the content concerning the request for viewing details from the storage unit 11 (step S25). The publication processing unit 22 transmits the read-out content to the terminal device 5 (step S26) and terminates the processing.

FIG. 7 shows an example non-limiting flowchart illustrating a procedure of reward giving processing for a contributor, performed by the content sharing server apparatus 1. It is noted that, in the present flowchart, the case where a vote is accepted as evaluation will be described while acceptance of comments will not be described. Also in the present flowchart, voting for content will be described while voting for the user who contributed the content will not be described. The evaluation acceptance processing unit 23 in the processing unit 10 of the content sharing server apparatus 1 determines whether or not a vote is accepted from the terminal device 5 (step S31). If a vote is accepted (S31: YES), the evaluation acceptance processing unit 23 additionally register the voted content under the bookmark of the user who performed the voting (step S32).

The reward giving processing unit 24 in the processing unit 10 aggregates the number of coins obtained by voting with respect to the voted content (step S33). The reward giving processing unit 24 determines whether or not the number of obtained coins for the content satisfies a delete exemption condition (step S34). If the number of obtained coins does not satisfy the delete exemption condition (S34: NO), the processing unit 10 returns the processing to step S31. If the number of obtained coins satisfies the delete exemption condition (S34: YES), the reward giving processing unit 24 invalidates the setting of the delete period for this content (step S35). In the case where the delete period is not set for the content, i.e. where the content is contributed using a special coin, for example, the processing unit 10 may proceed to step S36 without performing the processing of step S35.

The reward giving processing unit 24 in the processing unit 10 determines whether or not the number of obtained coins for content satisfies a ticket obtaining condition (step S36). If the ticket obtaining condition is not satisfied (S36: NO), the reward giving processing unit 24 returns the processing to step S31. If the ticket obtaining condition is satisfied (S36: YES), the reward giving processing unit 24 gives a “service use ticket” to the user who contributed the content (step S37) and returns the processing to step S31.

If a vote for content is not accepted (S31: NO), the processing unit 10 determines whether or not it is the timing at which the popularity ranking of content is announced, i.e. the end of the month, for example (step S38). If it is not yet the timing at which the popularity ranking is announced (S38: NO), the processing unit 10 returns the processing to step S31. If it is the timing at which the popularity ranking is announced (S38: YES), the processing unit 10 decides the popularity ranking for content based on the result of aggregation for the votes accepted by the evaluation acceptance processing unit 23. The publication processing unit 22 publishes the popularity ranking (step S39). The reward giving processing unit 24 in the processing unit 10 gives an “additional coin ticket” to the user who contributed the content ranked high in the popularity ranking (step S40), and returns the processing to step S31.

FIG. 8 shows an example non-limiting flowchart illustrating a procedure of reward giving processing for an evaluator, performed by the content sharing server apparatus 1. The processing illustrated in the present flowchart is performed for each content stored in the content sharing server apparatus 1. The evaluation acceptance processing unit 23 in the processing unit 10 of the content sharing server apparatus 1 determines whether or not a vote for content is accepted from the terminal device 5 (step S51). When a vote is accepted (S51: YES), the reward giving processing unit 24 in the processing unit 10 obtains evaluation for content at the time of voting (step S52). The reward giving processing unit 24 stores the user who made the evaluation and the result of evaluation on the evaluated content in the storage unit 11 by associating them with each other (step S53), and returns the processing to step S51.

If a vote is not accepted from the terminal device 5 (S41: NO), the processing unit 10 determines whether or not a predetermined period has elapsed from the voting of content (step S54). If the predetermined period has not elapsed (S54: NO), the processing unit 10 returns the processing at step S51. If the predetermined period has elapsed (S54: YES), the reward giving processing unit 24 of the processing unit 10 obtains the evaluation on content at the current time point (step S55). The reward giving processing unit 24 calculates a difference between the evaluation at the time of voting and the evaluation at the current time point for each user who voted for the content (step S56). The reward giving processing unit 24 gives an evaluation point in accordance with the calculated different to the user who voted for the content (step S57) and terminates the processing.

FIG. 9 shows an example non-limiting flowchart illustrating a procedure of reward giving processing for an evaluator, performed by the content sharing server apparatus 1. The processing unit 10 of the content sharing server apparatus 1 determines whether or not a request for viewing the bookmark of another user is accepted from the terminal device 5 (step S71). If the request for viewing the bookmark is accepted (S71: YES), the publication processing unit 22 in the processing unit 10 reads out the bookmark according to the request and transmits it to the terminal device 5 (step S72).

The processing unit 10 performs processing of accepting the request for viewing content based on the transmitted bookmark from the terminal device 5 (step S73). The processing unit 10 transmits the content concerning the accepted viewing request to the terminal device 5 (step S74). The processing unit 10 performs processing of accepting a vote for content (step S75). The reward giving processing unit 24 in the processing unit 10 gives an evaluation point to the owner of the bookmark used to view the content for which a vote is accepted (step S76), and returns the processing to step S71.

If the request for viewing a bookmark is not accepted (S71: NO), the processing unit 10 determines whether or not it is the timing at which the ranking concerning the use of bookmark is to be announced, such as the end of that month (step S77). If it is not the timing at which the ranking is to be announced (S77: NO), the processing unit 10 returns the processing to step S71. If it is the timing at which the ranking is to be announced (S77: YES), the processing unit 10 determines the ranking for bookmark based on the total value of the evaluation points given by the reward giving processing unit 24 to the owner of each bookmark. The publication processing unit 22 in the processing unit 10 publishes the ranking (step S78). The reward giving processing unit 24 in the processing unit 22 gives a “service use ticket” to the user who owns a highly-ranked bookmark in the ranking (step S79), and returns the processing to step S71.

In the content sharing system according to the present embodiment with the configuration described above, the content sharing server apparatus 1 accepts, by the contribution acceptance processing unit 21, contribution of content created at the terminal device 5. The content sharing server apparatus 1 stores the content, contribution of which is accepted, in the storage unit 11. The publication processing unit 22 of the content sharing server apparatus 1 publishes the stored content. The publication processing unit 22 publishes content by transmitting a content list or content to the terminal device 5 based on the request from the terminal device 5. The content sharing server apparatus 1 accepts a vote, comment or the like for the published content by the evaluation acceptance processing unit 23. The reward giving processing unit 24 of the content sharing server apparatus 1 gives a reward to the user who made evaluation on content.

This allows the user who evaluates content to be highly motivated for such action of evaluating content.

In the content sharing system according to the present embodiment, the reward giving processing unit 24 of the content sharing server apparatus 1 gives an evaluation point, a “service use ticket” and/or the like as a reward. As a result, the content sharing system gives, as a reward, a coin to be used in the service. The coin given here corresponds to numeric information having a value. The evaluation acceptance processing unit 23 of the content sharing server apparatus 1 accepts evaluation on content with consumption of the coin, i.e. reduction in the value of value information, supplied or given as a reward in using the service.

Thus, the cycle of coin utilization may be realized by giving coins to an evaluator of content and consuming coins by an evaluator.

The “value information” given to a user includes:

an item valuable in the real world;

an item that itself is chargeable (that is to be directly given with reception of a payment); and

an item to be indirectly given with a paid “service use ticket” or the like.

In other words, the “value information” is not limited to a special coin or normal coin but may be other different types of things. The “value information” may include, in addition to the coin, ticket or the like as in the present embodiment, virtual currency usable in an application such as a game, a cashable point, a point which is not cashable but may be exchanged with a gift or the like, electronic money and the like.

The reward giving processing unit 24 of the content sharing server apparatus 1 gives a “service use ticket” so as to give an authority to use the content sharing system as a reward. This allows the user to use the content sharing system free of charge. The user may thus be highly motivated for the action of evaluating content.

The reward giving processing unit 24 of the content sharing server apparatus 1 calculates the number of coins voted for content as a popularity indicator for that content. The reward giving processing unit 24 gives a reward in accordance with the popularity indicator for the content to the voter who voted for the content. For example, the reward giving processing unit 24 gives an evaluation point in accordance with the change, i.e. difference, between the popularity indicator for the content at the time of voting and the popularity indicator at the time point when a predetermined period has elapsed, to the evaluator of the content. This allows the evaluator to feel the joy of finding and evaluating the content or contributor that has not yet been highly evaluated but may presumably be highly evaluated in the future. It is noted that the popularity indicator for content may also be calculated based on information other than the number of coins, i.e. amount of value information, used by another user to vote for the content. For example, the popularity ranking may be calculated based on the number of registrations in bookmarks, the number of users who registered the content in their bookmarks, the number of times the content is viewed, the number of times the content is evaluated and the like.

The content sharing server apparatus 1 makes it possible to create a bookmark, i.e. information on an evaluated object (hereinafter also referred to as evaluation object information), in accordance with votes by users and to publish the bookmark. The reward giving processing unit 24 gives an evaluation point as a reward to the user who owns the published bookmark when another user views and evaluates content with reference to that bookmark. The reward giving processing unit 24 creates ranking in accordance with, for example, the number of times the bookmark is used in a predetermined period such as one month. The reward giving processing unit 24 gives a “service use ticket” as a reward to the user who owns a highly ranked bookmark in the ranking. Accordingly, the user who evaluated content may receive a reward depending on the evaluation details.

Though a bookmark is described as an example for the “evaluation object information” in the present embodiment, this is a mere example. The “evaluation object information” may also be, for example, information on the list of user's evaluation history or the like, or may be other than the above. Though such a configuration is employed in the present embodiment that registration in a bookmark is performed when evaluation is made for content or contributor, the configuration is not limited thereto. Another configuration may also be employed in which, for example, content or contributor is registered in a bookmark by the user performing registering operation to the bookmark. In such a case, the registering operation into the bookmark performed by the user may be regarded as one of the evaluations and added to calculation of a popularity indicator.

The reward giving processing unit 24 of the content sharing server apparatus 1 gives a reward to the user who contributed content. For example, the reward giving processing unit 24 exempts deletion of the content contributed using a normal coin when the number of coins obtained by the content satisfies a delete exemption condition. When, for example, the number of coins obtained by a user from votes for content and votes for contributor satisfies the ticket obtaining condition, the reward giving processing unit 24 gives a “service use ticket” to that user. For example, the reward giving processing unit 24 aggregates and announces the popularity ranking of content and gives an “additional coin ticket” to the contributor of highly ranked content.

This allows the contributor of content to be highly motivated for the action of creating and contributing content.

In the content sharing server apparatus 1, the reward giving processing unit 24 eventually gives coins to the contributor of content. In the content sharing server apparatus 1, the contribution acceptance processing unit 21 accepts contribution of content with consumption of coins. Accordingly, the cycle of coin utilization may be realized by the contributor of content receiving and consuming coins. The cycle of coin utilization may also be realized by giving and consumption of coins concerning the contributor of content as well as giving and consumption of coins concerning the evaluator of content.

In the content sharing server apparatus 1, a “service use ticket” is used to supply the user with coins valid in a predetermined service use period of service. The user can use the coins to, for example, contribute and/or evaluate content. The upper limit is determined for the amount of coins supplied in the service use period depending on the user's level, and additional purchase of coins is not allowed. The “service use ticket” and “additional coin ticket” given to the user as rewards also have determined periods of validity. As for the content contributed using a normal coin, the content holding period is set. The content which passes the content holding period is deleted from the storage unit 11 of the content sharing server apparatus 1. Such restrictions limits the number of coins a user can use in the service use period of service, whereby the quality of contributed content, evaluation on content and the like may be enhanced. Compared to the case without such restrictions, the number of contributed contents and evaluations may be reduced, so that the processing load can be reduced in the content sharing server apparatus 1.

While in the present embodiment the content sharing service is set as chargeable, the service may alternatively be realized as a free service. It is also possible to offer a part of the service free of charge. For example, the service may be offered free for one month from the first use of the service, or offered free when used the service during a special time zone such as 16:00 to 18:00. Here, the service offered free of charge may be limited to only viewing of contributed content. It may also be so configured that, in the case where the service is offered free, an evaluator can evaluate by voting or making comments using neither a normal coin nor a special coin. The reward giving processing unit 24 of the content sharing server apparatus 1 can determine whether or not a “service use ticket” for use in the content sharing service is given to the user who contributed content in accordance with the number of votes for content or contributor, or the number of users who voted, not with the number of coins used for voting.

Though it is so configured that additional purchase of coins is not allowed, it may also be so configured that coins may be supplied with a payment of additional fee. In such a case, a normal coin or special coin may directly be given as a reward to the contributor or evaluator who satisfies the above-described conditions, instead of a “service use ticket.” While two types of normal and special coins are used here, the configuration is not limited thereto but may employ a single type of coin or more than two types of coins.

Though it is configured to give a reward to the user who voted for content as evaluation, the configuration is not limited thereto. For example, the user who makes comments on content may be provided with a reward. For another example, a vote in favor of or opposed to a comment may be accepted to calculate the approval rate (number of votes in favor/number of votes), and the user may be provided with a reward according to the approval rate.

The allocation of the functions in the configuration and devices in the content sharing system is not limited to the one described in the present embodiment. For example, at least a part of the functions described to be performed by the content sharing server apparatus 1 in the present embodiment may be performed by the terminal device 5. On the contrary, at least a part of the functions described to be performed by the terminal device 5 may alternatively be performed by the content sharing server apparatus 1. It may also be possible to realize the functions of the content sharing server apparatus 1 by multiple server apparatuses, not by a single server apparatus.

Modification

The reward giving processing unit 24 of the content sharing server apparatus 1 may provide an evaluator of content with the right to communicate with the contributor of that content as a reward. For example, the reward giving processing unit 24 calculates the difference between the evaluations on content at the time of voting and at the time when a predetermined period has elapsed, and gives the right to communicate with the contributor when the difference exceeds a threshold. The reward giving processing unit 24 accepts a message to be transmitted to the contributor of the content from the evaluator and transmits the accepted message to the contributor. The contributor who receives the message may send a replying message to the evaluator. Whether or not the contributor sends a reply, however, depends on the judgment of the contributor.

Modification

It may also be so configured that the user is able to, not only view the content stored in the storage unit 11 by the content sharing server apparatus 1 at the terminal device 5, but also download the content to the storage device 51 of the terminal device 5. For example, the content sharing server apparatus 1 accepts downloading of content with the consumption of a special coin. The content sharing server apparatus 1, which accepted the request for downloading the content from the terminal device 5, reads out the content from the storage unit 11 and transmits it to the terminal device 5. The terminal device 5 stores the content received from the content sharing server apparatus 1 in the storage unit 51. Even in the case where the terminal device 5 cannot communicate with the content sharing server apparatus 1, the user can view the downloaded content at the terminal device 5. The content sharing server apparatus 1 adds the special coin used in downloading to the number of votes of the coins for that content, and determines a reward or ranking for the contributor.

When used in the present specification, each element or the like denoted in a singular form with a word “a” or “an” attached in front thereof is to be understood not to eliminate the possibility of a plurality of elements related thereto.

The content sharing system according to the present embodiment can enhance users' preference in evaluation for contributed content by accepting an evaluation from an evaluator with reduction in value of value information.

What is claimed is:

1. A content sharing system in which contributed content is published on a network so as to be shared among a plurality of users, comprising:
a terminal device accepting operation of contributing content by a contributor, or accepting operation by an evaluator of evaluating published content or evaluating a contributor who contributed content; and
a content sharing server apparatus including a value information providing unit providing value information to a user, a content contribution acceptance unit accepting contribution of content from a contributor through communication with the terminal device, and an evaluation acceptance unit accepting an evaluation, for contributed content or a contributor who contributed content, from an evaluator with reduction in value of the value information through communication with the terminal device.

2. The content sharing system according to claim 1, wherein the evaluation acceptance unit accepts a comment or a vote, for content or a contributor, as an evaluation.

3. The content sharing system according to claim 1, further comprising a contribution reward giving unit giving a reward to a contributor who contributed content.

4. The content sharing system according to claim 3, wherein the contribution reward giving unit gives a reward in accordance with an amount of value information reduced with the evaluation for the content or contributor.

5. The content sharing system according to claim 3, further comprising a popularity indicator calculation unit calculating a popularity indicator for content or a contributor concerning the evaluation accepted by the evaluation acceptance unit,
wherein the contribution reward giving unit gives a reward in accordance with the popularity indicator calculated by the popularity indicator calculation unit.

6. The content sharing system according to claim 5, wherein the popularity indicator calculation unit calculates a popularity indicator for a contributor based on at least one of the evaluations accepted by the evaluation acceptance unit for the contributor or for content contributed by the contributor.

7. The content sharing system according to claim 5, wherein the popularity indicator calculation unit calculates a popularity indicator based on at least one of the number of evaluations for the content or contributor and the number of evaluators who evaluated the content or contributor.

8. The content sharing system according to claim 3, wherein the contribution reward giving unit gives value information to a contributor as a reward.

9. The content sharing system according to claim 8, wherein the value information given as the reward has a determined period of validity.

10. The content sharing system according to claim 1, wherein the content contribution acceptance unit accepts a contribution of content with reduction in value of the value information.

11. The content sharing system according to claim 1, wherein the value information is valuable numeric information.

12. The content sharing system according to claim 1, wherein the value information providing unit provides value information effective in a predetermined period to a user.

13. The content sharing system according to claim 12, wherein an upper limit of an amount of value information provided by the value information providing unit to each user in a predetermined period is determined.

14. The content sharing system according to claim 1, wherein the user may be the contributor or the evaluator.

15. The content sharing system according to claim 1, wherein the content for which a contribution is accepted by the content contribution acceptance unit has a determined period during which an evaluation can be accepted by the evaluation acceptance unit.

16. A content sharing server apparatus in which contributed content is published on a network so as to be shared among a plurality of users, comprising:
a value information providing unit providing value information to a user;
a content contribution acceptance unit accepting a contribution of content from a contributor; and
an evaluation acceptance unit accepting an evaluation from an evaluator for contributed content or a contributor who contributed content with reduction in value of the value information.

17. A content sharing method of publishing contributed content on a network to share the content among a plurality of users, comprising:
providing value information to a user;
accepting a contribution of content from a contributor; and
accepting an evaluation from an evaluator for contributed content or a contributor who contributed content with reduction in value of the value information.

18. A non-transitory recording medium in which a computer program is recorded, the computer program making a computer operate as:
a value information providing unit providing value information to a user;
a content contribution acceptance unit accepting a contribution of content from a contributor; and
an evaluation acceptance unit accepting an evaluation from an evaluator for contributed content or a contributor who contributed content with reduction in value of the value information.

19. A content sharing system in which contributed content is published on a network so as to be shared among a plurality of users, comprising:
a terminal device; and
a content sharing sever apparatus,
wherein the terminal device performs the processing of:
accepting operation of contributing content by a contributor, or accepting operation by an evaluator of evaluating published content or evaluating a contributor who contributed content, and wherein the content sharing server apparatus performs the processing of:
providing value information to a user;
accepting contribution of content from a contributor through communication with the terminal device; and
accepting an evaluation, for contributed content or a contributor who contributed content, from an evaluator with reduction in value of the value information through communication with the terminal device.

20. A content sharing system in which contributed content is published on a network so as to be shared among a plurality of users, comprising:
one or more processing units;
wherein said one or more processing units perform the processing of:
accepting operation of contributing content by a contributor;
accepting operation by an evaluator of evaluating published content or evaluating a contributor who contributed content;
providing value information to a user;
accepting contribution of content from a contributor; and
accepting an evaluation, for contributed content or a contributor who contributed content, from an evaluator with reduction in value of the value information.
